(19) United States
(12) Patent Application Publication
(10) Pub. No.: US 2013/0132830 A1
(43) Pub. Date: May 23, 2013

(54) BEHAVIOR TEMPLATES

(71) Applicant: Bruce Chester Bell, New York, NY (US)

(72) Inventor: Bruce Chester Bell, New York, NY (US)

(73) Assignee: ADOBE SYSTEMS INCORPORATED, San Jose, CA (US)

(21) Appl. No.: 13/180,041

(22) Filed: Jul. 11, 2011

(51) Int. Cl. G06F 17/00

(52) U.S. Cl. 715/253

(57) ABSTRACT

A plurality of behavior templates is generated such that each of the plurality of behavior templates indicates a function that is performed by a corresponding element of a document. Further, a layout policy that indicates a corresponding fixed position in a layout of the document for each of the plurality of behavior templates is generated. The layout is composed by positioning the corresponding element associated with each of the plurality of behavior templates in the corresponding fixed position.

### BACKGROUND

1. Field

This disclosure generally relates to authoring environments. More particularly, the disclosure relates to digital layouts.

2. General Background

Digital layouts typically have to act differently across different viewing environments. For example, a user may author a digital layout for a document that may be seen on various viewing displays. The viewing environments may vary by display resolution, Pixels Per Inch (“PPI”), orientation, or the like. PPI is measured with respect to pixel density of any given display. As a result, a user may author a digital layout that can be comfortably viewed for a particular device, but is then to difficult to view on a completely different device. Accordingly, the user may have to author different digital layouts for different possible viewing devices for the same documents.

### SUMMARY

In one aspect of the disclosure, a computer program product is provided. The computer program product includes a computer useable medium having a computer readable program. The computer readable program when executed on a computer causes the computer to generate a plurality of behavior templates such that each of the plurality of behavior templates indicates a function that is performed by a corresponding element of a document. Further, the computer readable program when executed on the computer causes the computer to generate a layout policy that indicates a corresponding fixed position in a layout of the document for each of the plurality of behavior templates. In addition, the computer readable program when executed on a computer causes the computer to compose the layout by positioning the corresponding element associated with each of the plurality of behavior templates in the corresponding fixed position.

In another aspect of the disclosure, a process is provided. The process generates, with a processor, a plurality of behavior templates such that each of the plurality of behavior templates indicates a function that is performed by a corresponding element of a document. Further, the process generates, with the processor, a layout policy that indicates a corresponding fixed position in a layout of the document for each of the plurality of behavior templates. In addition, the process composes, with the processor, the layout by positioning the corresponding element associated with each of the plurality of behavior templates in the corresponding fixed position.

In yet another aspect of the disclosure, a system is provided. The system includes a reception module that receives a layout of a document composed according to a layout policy. The layout policy indicates a corresponding fixed position in the layout for each of a plurality of behavior templates that indicates a function that is performed by a corresponding element of the document. The system also includes a resolution module that automatically configures a resolution of the layout to match a device resolution in which the document is displayed without modifying the corresponding fixed position and the function for the corresponding element.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a behavior template configuration.

FIG. 2 illustrates an example of behavior templates that may be utilized for a layout.

FIG. 3 illustrates an example of a digital page that is composed from the behavior templates illustrated in FIG. 2.

FIG. 4 illustrates a process that composes a layout with behavior templates.

FIG. 5 illustrates a system configuration that may be utilized for generating behavior templates.

### DETAILED DESCRIPTION

A behavior template may be utilized to allow a content author to indicate the behaviors of elements in the layout of a document and the position of those elements in the document. A content author may generate a layout policy in an authoring environment to lock certain parts of the display, scale, float, mask/unmask, or the like. At runtime, the layout policy is then honored. In one embodiment, the same layout may be viewed across various display resolutions as the display resolution is reconfigured at runtime based on the layout policy referencing the available area to display content. In other words, a user may author a layout once and publish anywhere on various devices.

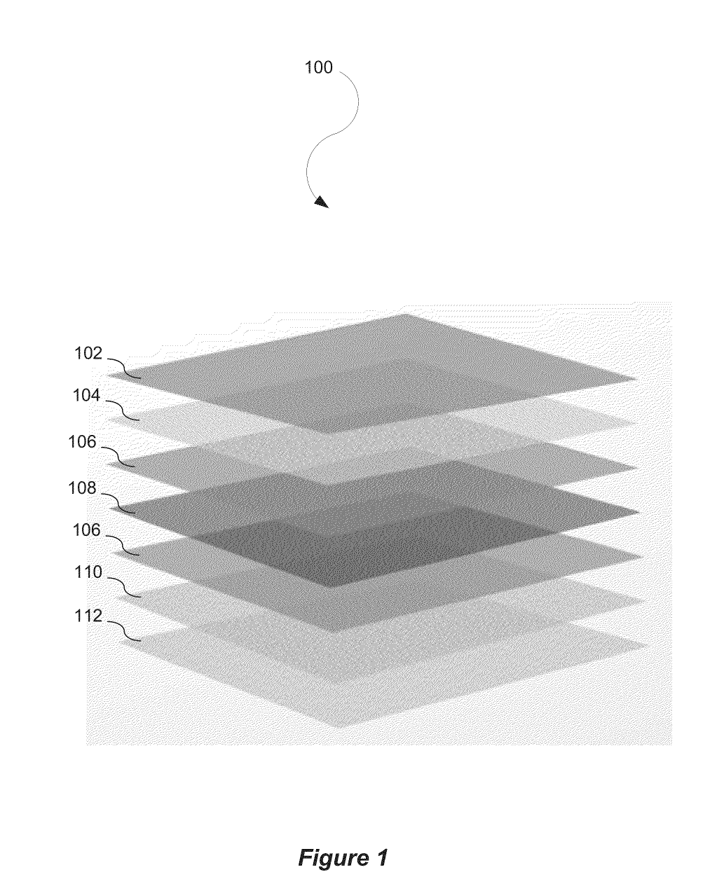

FIG. 1 illustrates a behavior template configuration 100. The behavior template configuration includes a set of behavior templates that each determines what function is performed by each element in a layout of a document rather than positions of the elements in the document. The term position is intended to mean x and y coordinates. As an example, an element that has a flexible behavior allows a user to lock a portion, e.g., a corner, to particular x and y coordinates. The remainder of that element may not be locked to those coordinates. A set of one or more rules may be utilized to determine how the remainder of the element is allowed to flex. For instance, a square with flexible behavior functionality may have its upper left hand corner locked to particular x and y coordinates and have a set of rules that allows the remainder of the square to be flexed horizontally to the right a certain percentage and then flex horizontally back to the left a certain percentage. In contrast, an element with static functionality would have all of its coordinates locked to particular x and y coordinates. A layout file may have a layout that is utilized to determine the positions of the elements in the document. The layout may be determined by a layout policy. In other words, an order of the layers may determine an order of the elements. A layer on top of another layer may obscure the layer beneath. An example of a document is a digital magazine. Accordingly, the layout of the digital magazine may provide a framework of a page in that digital magazine. That framework may then be utilized for different pages in the digital magazine. In other words, a layout policy for a digital magazine may allow a user to easily layout an article that can be read on different screens such that different layers may be read on those different screens. The layout policy may be applied to a set of objects in various other environments such as HTML, print publishing, vector graphics, generative vector artwork that is code to determine the shape of objects, images, etc.

As an example, the set of behavior templates may include a flexible section element 102, a flexible content element 104, a static content element 106, a scrolling content element 108, a static background element 110, and a canvas 112. The set of behavior templates may be utilized according to various configurations. For example, a flexible section element 102 may positioned on top of a flexible content element 104, which may be positioned on top of a static content element 106, which may be positioned on top of a scrolling content element 108, which may be positioned on top of a static content element 106, which may be positioned on top of a static background element 110, which may be positioned on top of a canvas 112. Various other configurations may be utilized.

The behavior template configuration 100 may be a desirable stacking order for the elements at play. For example, the flexible section element 102 may be text or another item that the author wants to always be visible and never covered by any of the other flexible elements. The flexible content element 104, the static content element 106, and the scrolling content element 108 may be image elements assigned to specific regions whose masks scale respectively and proportionally to the display resolution. Further, the static background element 110 may be a flexible background element which scales under all of the elements. In addition, the canvas 112 may be a static background element that sits at the size of the display resolution.

The canvas 112 is an element that performs the functionality of an application background. In other words, other elements may be stacked on top of the canvas 112. The canvas may have certain properties such as color, size, etc. The canvas 112 may be a background graphic or pattern.

Further, the static background element 110 may be a branded graphic element that provides the layout with an indication of the identity of the document. Other elements may overlay this element. Further, other elements may scroll/swipe on top of this element. Although the static background element 110 is fixed, the static background element 110 may be 9-sliced to flex with the desired aspect ratio. The term 9-slicing refers to a method of defining regions on an object by which the object scales by slicing the object into nine parts. The middle region is what scales proportionately so that the end rendering is preserved. An example is stretching a button with rounded corners. The corner radii of the button remain intact.

In addition, the scrolling content element 108 is the main element that may scroll or swipe over the static background element 110. An example of the scrolling content element 108 is scrolling text. Another example of the scrolling content element 108 is a scrolling image. The scrolling elements may be locked to a certain axis that are not locked to a certain screen, but are locked to a line to be swiped back and forth.

The static content element 106 maintains viewability and is immovable except within a mask or a spring-and-bumper defined area. Spring and bumpers refer to both the placement and the scaling of an object. The springs are the scalable areas of an element, and the bumpers are the fixed elements of a region or where the elements stops scaling or stretching. However, the static content element 106 still remains viewable even within a mask or a spring-and-bumper. The static content element does not scroll out of view. An example of a static content element 106 is a headline. Another example of a static content element 106 is an image. The scrolling content element 108 may move under or around the static content element 106. Further, multiple layers of static elements 106 may be utilized.

In addition, the flexible content element 104 is a branded graphic element, e.g., an image, that provides an indication of the identity of the document, but also provides context of a section or feature for the viewable page. Although the flexible content element 104 is constant, the flexible content element 104 may change from page to page. In other words, the flexible content element 104 may flex to fit across different displays. Further, the flexible content element 104 may be 9-sliced to flex during vertical scrolling.

The canvas 112 may be utilized in a variety of environments. For example, the canvas 112 may be applied to games or an interactive feature of a digital magazine to hide and show elements below it. Various layers may also be utilized for containers rather than objects. As an example, a layer may be utilize for a container such as a text frame that shows and hides text based on the behavior of text in different environments. Further, a layer may utilize a layer for a container such as an image frame. The images can be masked and unmasked based on the behavior of the image frame. Image frames can stretch based on policies for background colors or images.

In contrast with traditional layers that have fixed behaviors determined during authoring, behaviors of the elements described herein are determined at runtime. Those behaviors may react to one or more rules in the layout policy regarding the environment at runtime, user inputs, and the behavior of other elements. Further, the behaviors described herein may react differently in different environments whereas traditional layers have fixed behaviors independent of environment.

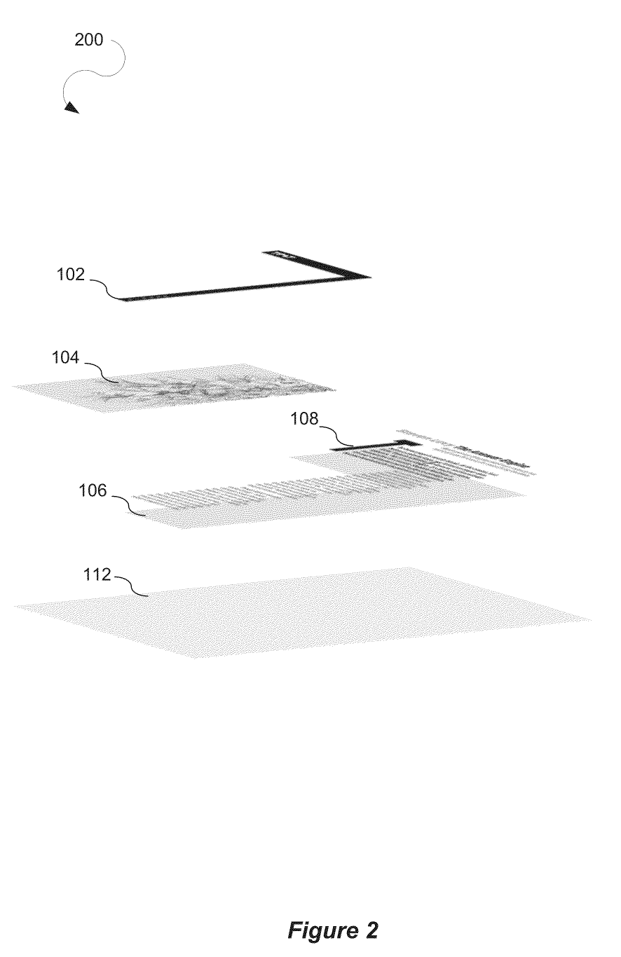

FIG. 2 illustrates an example of behavior templates that may be utilized for a layout 200. A canvas 112 may be utilized as the bottom layer. Further, a scrolling content element 108 such as scrolling text may be placed on top of a static content element that is placed on top of the virtual canvas 112. Further, a flexible content element 104 may be a design element that is placed on top of the scrolling content element 108 layer. Finally, a flexible section element 102 element may be placed on top of the flexible content element 104.

In one embodiment, a layout policy is generated to lock the different elements into position. In other words, the behavior templates indicate the functions performed by the various elements and the layout policy indicates the relative positions of those content elements.

In another embodiment, the flexible section element 102 may be 9-sliced so that the horizontal axis is static and the vertical axis scales. Further, the flexible content element 104 may be an image element assigned to a particular region. The mask of the flexible content element 104 may scale respectively and proportionally to the display resolution. For examples, spring and bumpers may be utilized so that the top and bottom are locked to a specific distance from the edge of the screen while the middle flexes appropriately. The scrolling content element 108 layer may be a text frame that scales respectively and proportionally to the display resolution while the text reflows inside of the text frame, which allows for reflow to the next page or increasing overset type values. The static content element 106 is a flexible background element that scales proportionally. Further, the virtual canvas 112 may be a static background element.

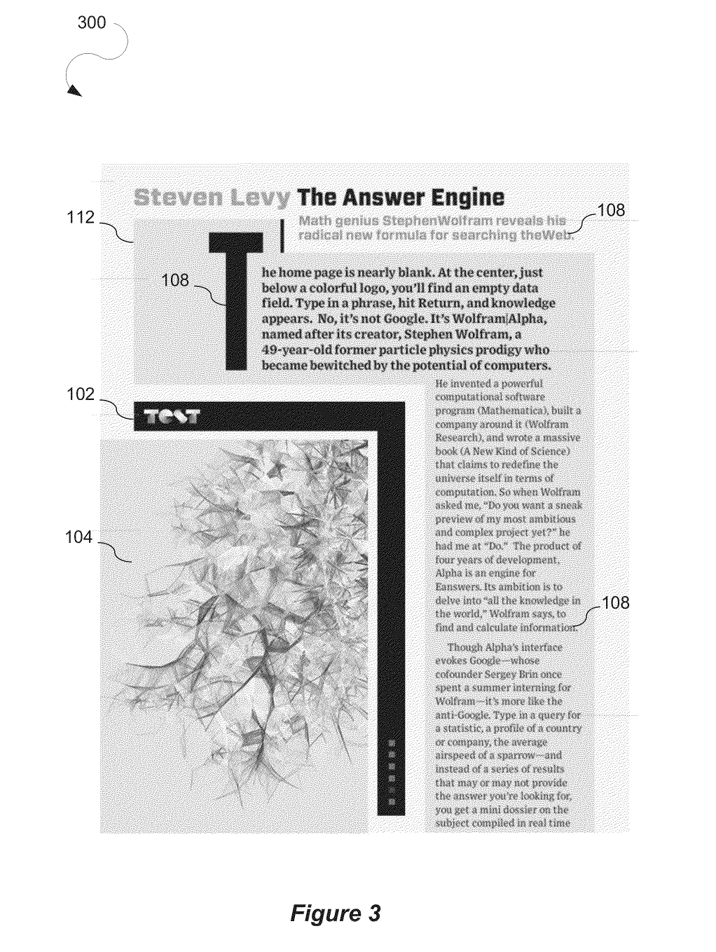

FIG. 3 illustrates an example of a digital page 300 that is composed from the behavior templates illustrated in FIG. 2. The digital page 300 has a variety of different pieces such as scrolling text, a design, and content. The different behavior templates ensure that the components of the digital page perform as indicated. For example, the scrolling text is a scrolling content element 108 that is viewable at all times. Further, the flexible content section 102 is situated on top of the flexible content element 104.

If the digital page 300 is viewed on different devices, layout policy ensures that the relative positions of the elements are maintained. Further, the behavior templates ensure that the functionality of the different elements is maintained. For example, the digital page illustrates the scrolling content element 108 being a certain distance from the flexible content element 102. If the digital page is viewed on a different device, that distance is scaled so that the overall digital page appears substantially similar from device to device. In other words, each element occupies a certain relative portion of the layout 200 irrespective of device resolution.

The elements provided herein are illustrated only as examples. Other elements may be utilized with behavior templates that ensure functionality for different elements and a layout policy that locks in positions of the elements relative to the layout 200.

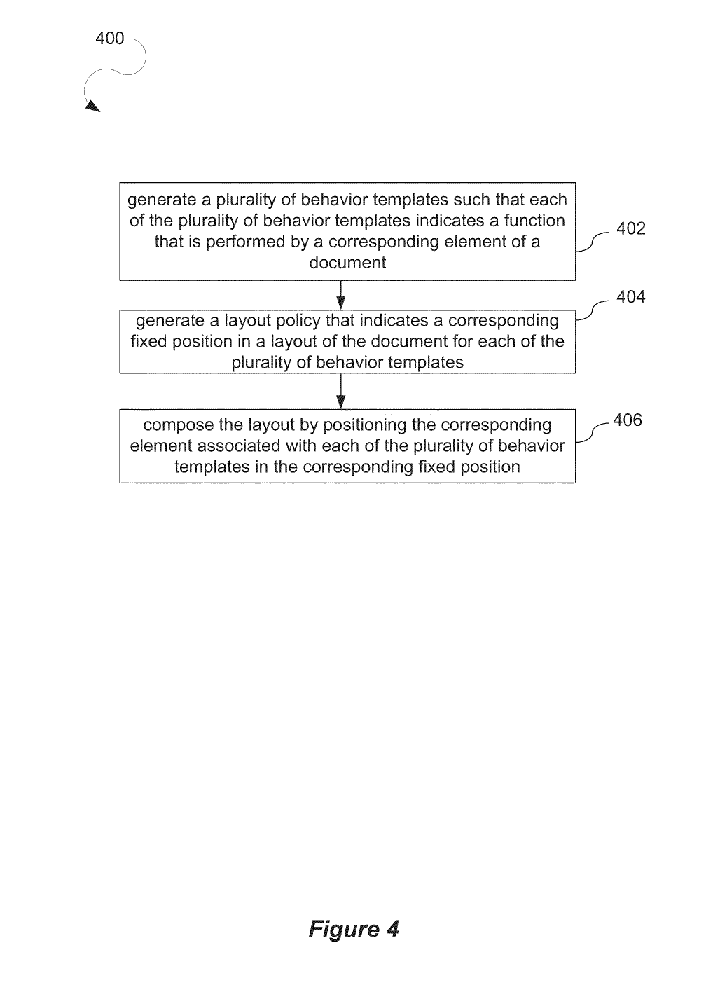

FIG. 4 illustrates a process 400 that composes a layout with behavior templates. At a process block 402, the process 400 generates, with a processor, a plurality of behavior templates such that each of the plurality of behavior templates indicates a function that is performed by a corresponding element of a document. Further, at a process block 404, the process 400 generates, with the processor, a layout policy that indicates a corresponding fixed position in a layout of the document for each of the plurality of behavior templates. In addition, at a process block 406, the process 400 composes, with the processor, the layout by positioning the corresponding element associated with each of the plurality of behavior templates in the corresponding fixed position.

Any of the configurations described herein may be utilized with a variety of graphic layout programs. Further, any of the configurations described herein may be applied to a text application such as a word processing program to incorporate layout policies when publishing a document. In addition, any of the configurations described herein may be utilized to assign behaviors to objects regardless of the application environment.

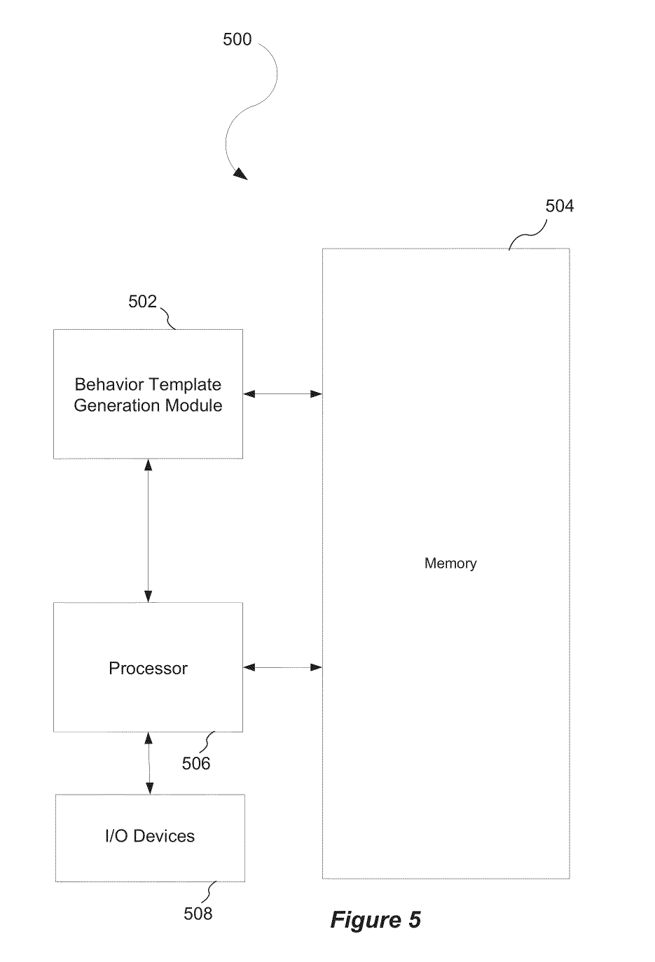

FIG. 5 illustrates a system configuration 500 that may be utilized for generating behavior templates. In one embodiment, a behavior template generation module 502 interacts with a memory 504. In one embodiment, the system configuration 500 is suitable for storing and/or executing program code and is implemented using a general purpose computer or any other hardware equivalents. The processor 506 is coupled, either directly or indirectly, to the memory 504 through a system bus. The memory 504 can include local memory employed during actual execution of the program code, bulk storage, and/or cache memories which provide temporary storage of at least some program code in order to reduce the number of times code must be retrieved from bulk storage during execution.

The Input/Output (“I/O”) devices 508 can be coupled directly to the system configuration 500 or through intervening input/output controllers. Further, the I/O devices 508 may include a keyboard, a keypad, a mouse, a microphone for capturing speech commands, a pointing device, and other user input devices that will be recognized by one of ordinary skill in the art. Further, the I/O devices 508 may include output devices such as a printer, display screen, or the like. Further, the I/O devices 508 may include a receiver, transmitter, speaker, display, image capture sensor, biometric sensor, etc. In addition, the I/O devices 508 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Network adapters may also be coupled to the system configuration 500 to enable the system configuration 500 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

1. One or more computer useable storage media storing a computer readable program, wherein the computer readable program when executed on a computer causes the computer to:
generate a plurality of behavior templates to define behaviors for elements in a digital document such that each of the plurality of behavior templates indicates a function that is performed by a corresponding element of the digital document;
generate a layout policy that defines a layout for the digital document and indicates a corresponding fixed position in the layout of the document for each of the plurality of behavior templates, the layout policy configured to include rules applicable to the behavior templates to cause different behaviors for the elements in different viewing environments corresponding to different computing devices to maintain the same layout defined by the layout policy across the different viewing environments; and
compose the layout by positioning the corresponding element associated with each of the plurality of behavior templates in the corresponding fixed position.

2. The computer useable storage media of claim 1, wherein the corresponding element is a canvas that is an application background.

3. The computer useable storage media of claim 1, wherein the corresponding element is a static background element that is immovable and overlayable.

4. The computer useable storage media of claim 1, wherein a movable element moves over the static background element.

5. The computer useable storage media of claim 4, wherein the movable element is selected from the group consisting of scrolling text and a scrolling image.

6. The computer useable storage media of claim 1, wherein the corresponding element is a static content element that maintains viewability and is immovable except within a mask or a spring-and-bumper defined area.

7. The computer useable storage media of claim 6, wherein moveable elements move around or under the static content element.

8. The computer useable storage media of claim 1, wherein the corresponding element is a flexible section element that maintains viewability and is immovable except within a mask or a spring-and-bumper defined area.

9. The computer useable storage media of claim 8, wherein moveable elements move around or under the flexible section element.

10. The computer useable storage media of claim 1, wherein the corresponding element is a flexible content element that flexes during vertical scrolling.

11. A method comprising:
generating, with a processor, a plurality of behavior templates that define behaviors for elements in a digital document such that each of the plurality of behavior templates indicates a function that is performed by a corresponding element of the digital document;
generating, with the processor, a layout policy that defines a layout for the digital document, indicates a corresponding fixed position in a layout of the document for each of the plurality of behavior templates, and contains rules applicable to the behavior templates to control elements of the digital document differently for different computing devices; and
composing, with the processor, the layout by positioning the corresponding element associated with each of the plurality of behavior templates in the corresponding fixed position in accordance with the rules contained in the layout policy.

12. The method of claim 11, wherein the corresponding element is a canvas that is an application background.

13. The method of claim 11, wherein the corresponding element is a static background element that is immovable and overlayable.

14. The method of claim 13, wherein a movable element moves over the static background element.

15. The method of claim 11, wherein the corresponding element is a static content element that maintains viewability and is immovable except within a mask or a spring-and-bumper defined area.

16. The method of claim 11, wherein the corresponding element is a flexible section element that maintains viewability and is immovable except within a mask or a spring-and-bumper defined area.

17. The method of claim 11, wherein the corresponding element is a flexible content element that flexes during vertical scrolling.

18. A system comprising:
modules stored on one or more computer-readable storage media, the modules including:
a reception module that receives a layout of a document composed according to a layout policy, the layout policy defining a layout for the document, indicating a corresponding fixed position in the layout for each of a plurality of behavior templates that indicates a function that is performed by a corresponding element of the document and, containing rules applicable to produce the defined layout for multiple device resolutions associated with different viewing devices; and
a resolution module that automatically configures a resolution of the layout in accordance with the rules to match a device resolution of a viewing device in which the document is displayed without modifying the corresponding fixed position and the function for the corresponding element.

19. The system of claim 18, wherein the layout of the document is composed independently of display parameters of a device.

20. The system of claim 18, wherein the document is a digital magazine.
